(19) United States
(12) Patent Application Publication
(10) Pub. No.: US 2014/0102590 A1
(43) Pub. Date: Apr. 17, 2014

(54) MONOCOQUE FURNITURE ASSEMBLY AND METHOD OF MANUFACTURE

(71) Applicant: Michael Towey, Culver City, CA (US)

(72) Inventor: Michael Towey, Culver City, CA (US)

(21) Appl. No.: 13/652,989

(22) Filed: Oct. 16, 2012

(51) Int. Cl. F16B 12/04; B27M 1/00

(52) U.S. Cl. 144/347; 403/345; 403/381; 403/364; 144/363

(57) ABSTRACT

A monocoque furniture assembly and method of manufacture is provided that utilizes modular wood segments connected by interlocking mating joints that are self-registering for ease of assembly and elimination of the need for special assembly tools. The monocoque structure achieves structural integrity with much thinner sheet material. The system can further include a series of reinforcing struts, trusses, ribs and doublers where required that distribute loads as well as a labeling protocol identifying mating assembly points and orientation thereby eliminating the need for lengthy assembly instructions, special skill or training.

### FIELD OF THE INVENTION

The present invention relates generally to furniture and related method of manufacture and, more particularly, to furniture formed from pre-scored unitary blanks.

### BACKGROUND OF THE INVENTION

Traditionally, furniture has been sold fully assembled by the manufacturer or factory. Traditional furniture utilizes conventional wood furniture fabrication techniques that consume a large amount of natural resources at great cost to the environment. In addition, since assembled furniture is generally bulky in size and heavy, the costs and logistics for the transportation of furniture is a concern for both the manufacturer and the consumer. In addition, a large amount of skill and training is required to produce a quality product. Traditional furniture requires the skill of a master carpenter, as well as a large assortment of woodworking tools and workspace.

With the advent of computer numerical control (CNC) wood routers, laser or water jet cutters, furniture manufacturers gained the ability to perform a large number of woodworking operations automatically and without special skills. With a computer with a computer-aided design or manufacture (CAD/CAM) program, the CNC tool can make accurate carvings from a digital design.

Moreover, “ready-to-assemble” or “knock-down” furniture is now widely popular due to cost efficient shipping and simple assembly. Ready-to-assemble furniture is typically packaged in one or more multiple boxes, containing screws, fasteners, and other parts required to assemble the furniture. As a result, products are more compact and easier to ship. However, the weight of the furniture is generally unchanged. Ready-to-assemble furniture is traditionally assembled furniture packaged in a kit form. Thus, while easier to ship, the furniture is still heavy, requiring comparable raw material resources and material as fully assembled furniture.

Whether fully assembled or ready-to-assemble, traditional furniture design typically requires a solid frame made of sturdy and rigid material to bear structural loads. Since the material used for the frame must have sufficient structural strength, it is commonly comprised of solid wood or metal tubing, and is relatively heavy.

It should be appreciated that there remains a need for furniture that is cost effective, minimizes use of material, sturdy, and easily transportable. The present invention solves these needs and others.

### SUMMARY OF THE INVENTION

Briefly, and in general terms, by example and not limitation, the invention provides ready-to-assemble furniture having a reinforced monocoque structure with interlocking mating joints that are self-registering for ease of assembly and does not require separate assembly tools. Additionally, the resulting furniture is formed of a plurality of planar components cut out from a flat panel of material, enabling an unassembled form to be shipped to the end user or for local assembly in an economical manner. Moreover, many economic benefits remain in the event that the furniture is shipped in an assembled form as weight is still dramatically reduced.

More specifically, an exemplary embodiment in accordance with the invention, the system achieves structural integrity with much thinner sheet material. Joints are located away from areas of high stress to maximize load-bearing capacity. The system can include a series of reinforcing struts, trusses, ribs and doublers where required that distribute loads as well as a labeling protocol identifying mating assembly points and orientation thereby eliminating the need for lengthy assembly instructions, special skill or training

In a detailed aspect of an exemplary embodiment in accordance with the invention, the pre-scored panel can include a protective cover adhered to the panel to protect the components during transport. Moreover, assembly instructions can be printed directly on the protective cover.

In another detailed aspect of an exemplary embodiment in accordance with the invention, furniture assembly excludes material near a central axis of structural members, particularly wherein the structure member is exposed primarily to loads that are generally parallel to central axis, rather than lateral loads.

Edge-to-edge joints can be used to join planar segments together. In the exemplary embodiment, corner edges are formed by box joints connecting adjacent segments. Flat joints can also use box joints as well as other conforming nonlinear edges. In other embodiments, various other joints can be used without departing from the invention, e.g., dovetail, combo, box, butt, corner halving, tongue-and-groove, rabbet, among others known in the art.

In another detailed aspect of an exemplary embodiment, the furniture assembly can further include a series of reinforcing struts, trusses, ribs and doublers where required that distribute loads as well as a labeling protocol identifying mating assembly points and orientation thereby eliminating the need for lengthy assembly instructions, special skill or training

A method of manufacturing a furniture assembly is also provided, which, by example and not limitation, can include providing a planar blank and scoring the planar blank to define a plurality of planar segments. Exemplary CNC tools include wood routers, laser, or water jet cutters, among others.

The pre-scored blank can thereafter be packaged for transport. Alternatively, the furniture can be assembly on site. Assembling the furniture piece includes removing the plurality of planar segments from the score blank, aligning corresponding segments of the plurality of segment, and applying glue to the edge-to-edge interlocking joints. The pre-scored blank can include assembly aids to assist in assembly, such as tool to hold the segments in place while the glue sets along the interlocking joints. The tool can further be used to aid in aligning corresponding furniture segments.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a perspective view of a first embodiment of a furniture assembly in accordance with the invention, depicting an end table formed of a plurality of planar wood segments formed in a reinforced monocoque structure.

FIG. 2 is a bottom perspective view of the furniture assembly of FIG. 1.

FIG. 3 is a plan view of a wood panel pre-scored to define the plurality of planar wood segments of the table of FIG. 1.

FIG. 4A is a perspective view of a second embodiment of a furniture assembly in accordance with the invention, in the form of a chair having a monocoque structure.

FIG. 4B is a close-up perspective view of a portion of the chair of FIG. 4A, depicting a transition region between a seat portion and a back portion of the chair.

FIG. 5 is a top perspective view of a third embodiment of a furniture assembly in accordance with the invention, in the form of a block having a reinforced monocoque structure.

FIG. 6 is a bottom perspective view of the furniture block of FIG. 5.

FIG. 7 is a partially exploded bottom perspective view of the furniture block of FIG. 5.

FIG. 8 is a plan view of a wood panel pre-scored to define the plurality of planar wood segments of the block of FIG. 5 in addition to some assembly aids.

FIG. 9 is a perspective view of several of the furniture blocks of FIG. 5 stacked together.

FIG. 10A is a partially exploded perspective view of the furniture block of FIG. 5 further having table top component added thereto.

FIG. 10B is a perspective view of the furniture block and table top of FIG. 10A.

FIG. 11 is a top perspective view of a fourth embodiment of a furniture assembly in accordance with the invention, depicting another block configuration having a monocoque structure.

FIG. 12 is a bottom perspective view of a fourth embodiment of a furniture assembly in accordance with the invention, depicting another block configuration having a monocoque structure.

FIG. 13 is a partially exploded perspective view of fifth embodiment of a furniture assembly in accordance with the invention, depicting a shelf assembly having a monocoque structure.

FIG. 14 is a close-up perspective view of a portion of a base of the shelf assembly of FIG. 13, depicting a transition region between a horizontal shelf and a back wall of the base assembly.

FIG. 15 is a close-up perspective view of a support panel of the base assembly of FIG. 13, as shown in the portion of the shelf assembly depicted FIG. 14.

FIG. 16 is a close-up perspective view of a corner support form of three support segments as depicted in FIG. 15.

FIG. 17A is a planar view of a panel pre-scored to define the plurality of planar wood segments of a table assembly in accordance with the invention, depicting a protective covering adhered to the panel having assembly instructions printed thereon.

FIG. 17B is a close-up view of the panel of FIG. 17A.

### DETAILED DESCRIPTION OF THE PREFERRED EMBODIMENTS

With reference now to the drawings, a system of furniture fabrication is depicted utilizing modular segments connected by interlocking mating joints that are self-registering for ease of assembly and elimination of the need for separate assembly tools.

Various examples of furniture items are depicted in the drawings, such as tables, chairs, shelves, and blocks. Each furniture item is configured as a reinforced monocoque structure from a plurality of thin, wood segments mated together to provide a structural skin as a chief means for bearing structural loads. Primary members of the furniture, e.g., tabletop, legs, and walls, are formed of several planar segments, in a monocoque configuration relieves the need of requiring solid load bearing members such as legs as is commonly employed with wood furniture. Joints connecting the segments are located away from areas of high stress to maximize strength. As a result, each furniture assembly includes hollow structural components, such as legs and walls, for load bearing members.

Using this approach, the furniture assembly can be configured to provide ample structural support while using substantially less material than traditional approaches, providing a furniture assembly that is sturdy, lightweight, and economical. Moreover, furniture can be transported unassembled in particularly compact, lightweight packages, further promoting cost savings.

The terms “monocoque structure” or “monocoque furniture,” unless otherwise specified, is intended to refer to a furniture assembly having a structural skin that serves as a load bearing component of the structure and further having prescribed structural features, which can include legs and walls that are substantially hollow. Such load bearing members can include reinforcements intermittently spaced throughout.

Edge-to-edge joints are used to join planar segments together. In the exemplary embodiment, corner edges are formed by box joints connecting adjacent segments. Flat joints can also use box joints as well as other conforming nonlinear edges. In other embodiments, various other joints can be used without departing from the invention, e.g., dovetail, combo, box, butt, corner halving, tongue-and-groove, rabbet, among others known in the art.

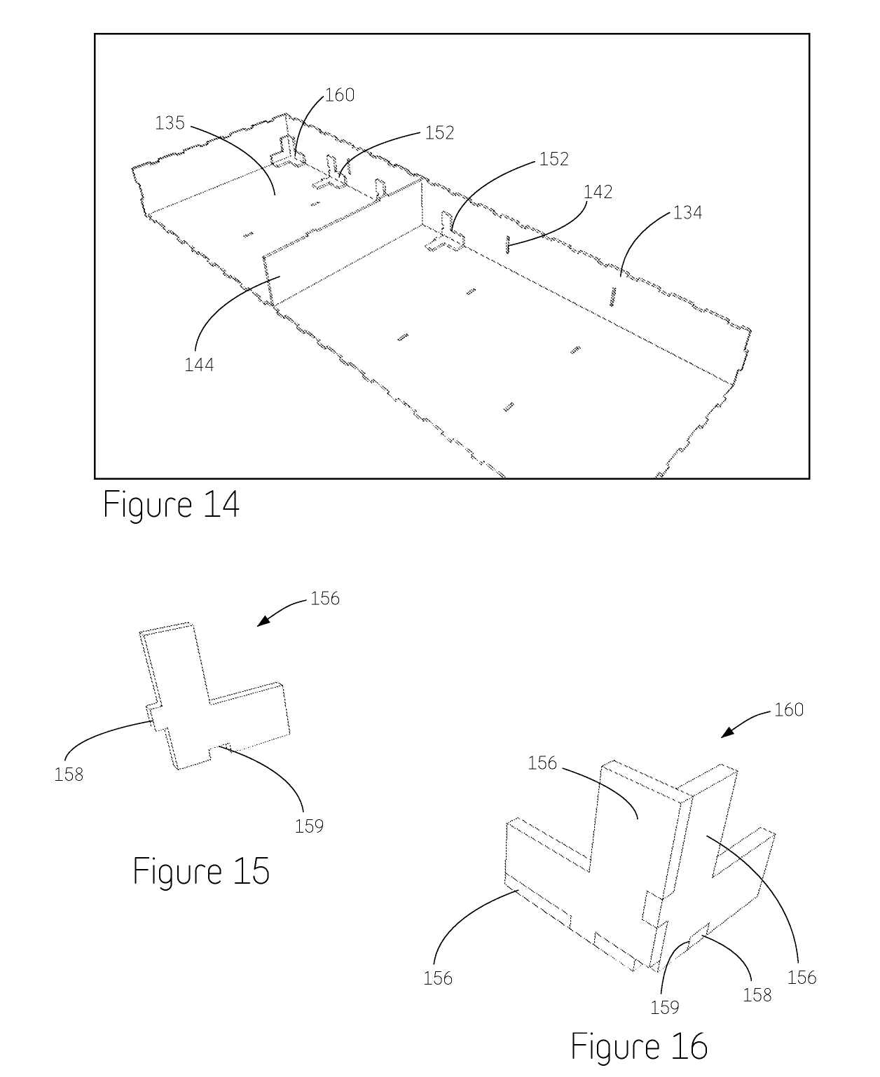

The system can further include a series of reinforcing struts, trusses, ribs and doublers where required that distribute loads as well as a labeling protocol identifying mating assembly points and orientation thereby eliminating the need for lengthy assembly instructions, special skill or training Various reinforcement techniques can be used in accordance with the invention to facilitate structural integrity while minimizing materials. For example, multi-layered planar segments on load bearing or work surfaces of furniture item, in which multiple segments in the same plane are joined. Trusses can be used to reinforce spans, for example, in which such spans are 8-30 times the wall thickness. Stacked trusses can be used for additional strength where appropriate. Edge and corner blocking at key load points can be used, such as those illustrated in FIG. 14, as discussed below. Areas where excessive stress does not occur during normal use are left un-reinforced to reduce material, weight, and assembly time.

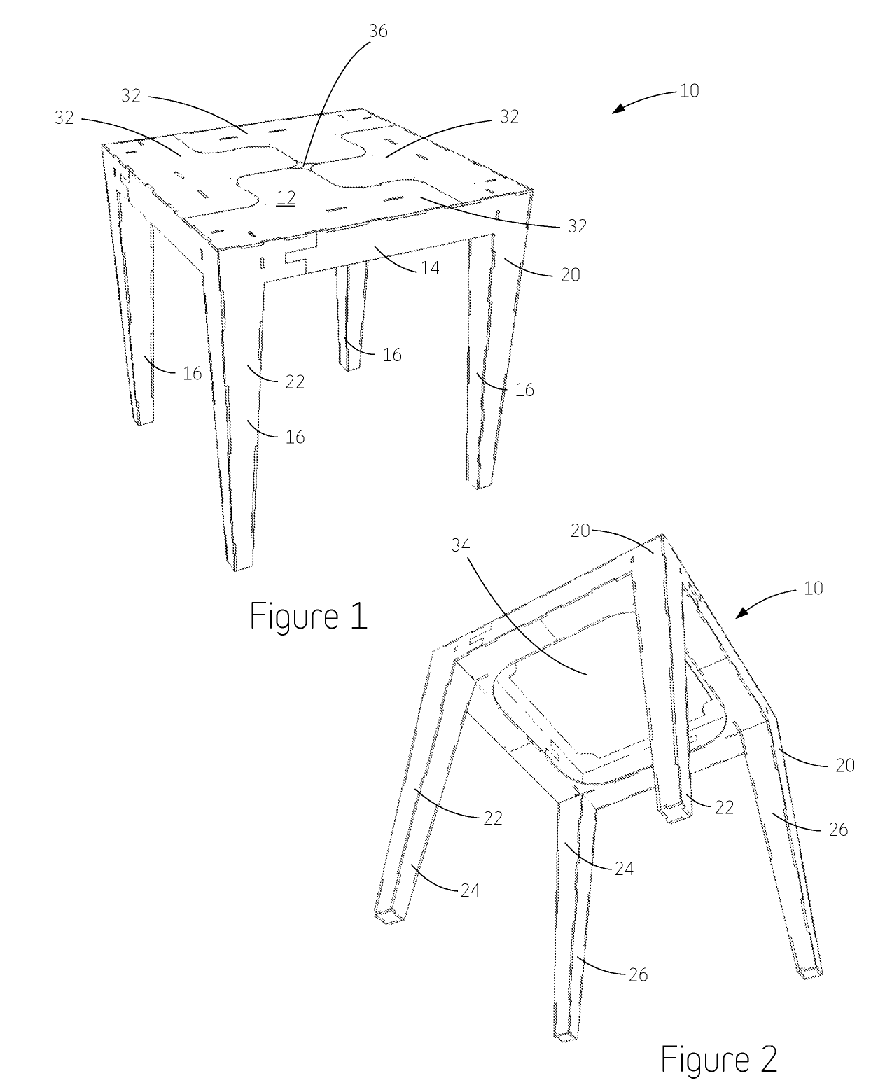

With reference now to FIGS. 1 and 2, a table 10 includes a plurality of thin wood segments (e.g., 14-32) coupled to form a reinforced monocoque structure. The table includes tabletop 12 and a skirt 14 that extends about the tabletop. Legs 16 of the table are four sided and hollow. The skirt and the legs are formed by several leg segments, outer leg segments 20, 22 and inner leg segments 24, 26, connected together by edge-to-edge joints spaced apart from high stress regions.

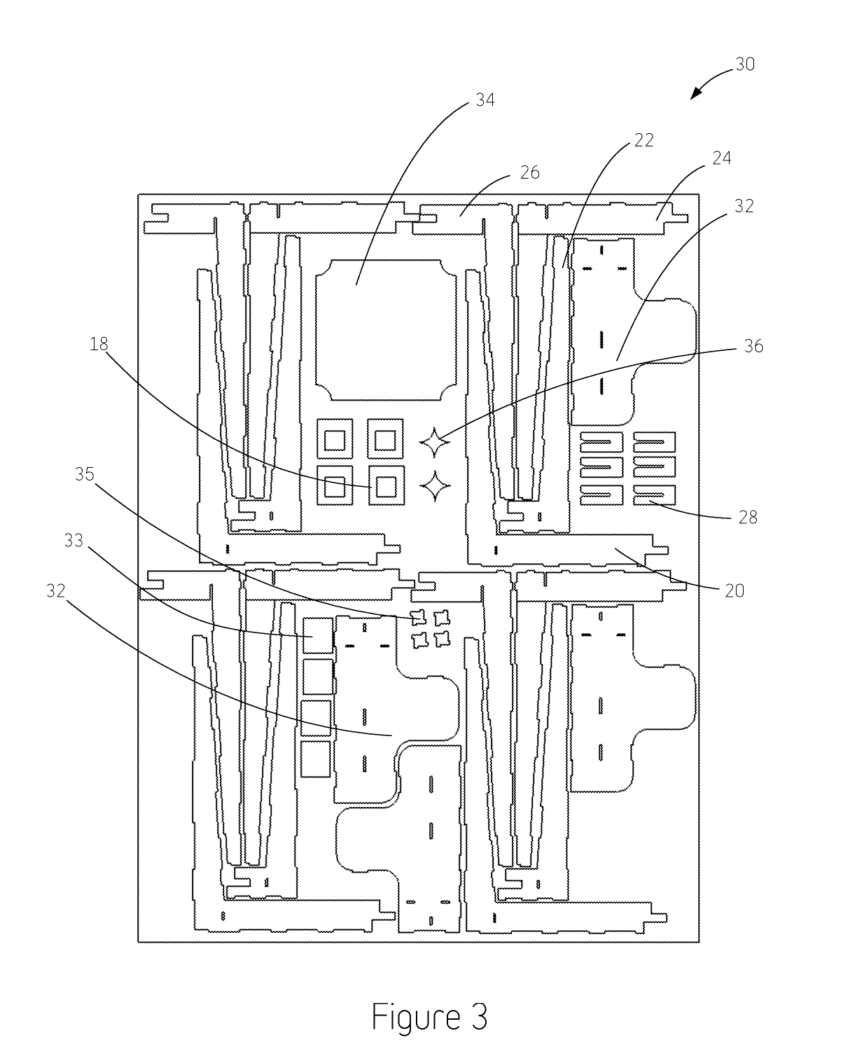

With reference now to FIG. 3, all wood segments of table 10 are formed from a single planar blank 30 having a thickness of about three millimeters. Preferably, the panel has a thickness of less than 10 millimeters. For example, the blank defines the outer leg segments 20, 22 and inner leg segments 24, 26 for forming the four legs of the table. Quarter segments 32 are used in the tabletop 12, and segment 34 provides support to the quarter segments in forming the tabletop (see also FIG. 2).

In an exemplary method of manufacture, the blank 30 is run through a computer numerical control tool (CNC) programmed to define the plurality of planar segments. Exemplary CNC tools include wood routers, laser, or water jet cutters, among others. The pre-scored blank can thereafter be packaged for transport. Alternatively, the furniture can be assembled on site. Assembling the furniture piece includes removing the plurality of planar segments from the score blank, aligning corresponding segments of the plurality of segment, and applying glue to the edge-to-edge interlocking joints. As discussed in further detail, the pre-scored blank can includes assembly aids to assist in assembly. For example, tool 18 can be used to hold the leg segments in place while the glue sets along the interlocking joints.

The blank 30 further provides a plurality of segments, e.g., 33 that are used throughout the table as connectors and for additional structural support, as well as, panel segments that are not part of the finished product; rather, they are used to facilitate construction as assembly aids (e.g., 18, 28). Foot segment 35 closes and supports the base of the leg. Tabletop segment 32 is used to as the ornamental inlay 36 (FIG. 1) in the center of the tabletop 12. It should be appreciated that the present invention enables easy implementation of complex decorative marquetry.

The panel 30 comprises a composite wood board and a maple veneer. Preferably, the panel has a thickness of less than 10 millimeters. More preferably, the panel has a thickness between about 3 mm to 7 mm, to meet anticipated design considerations. Various other panel materials can be used without departing from the invention, such as plywood, solid wood, hardboard, medium density fiberboard, wood/non-wood composites, or plastic sheeting. It will be observed that all of the segments for table 10 are cut from a single panel of wood, thereby optimizing available space and greatly reducing waste. This approach further eliminates the need for material lists and cut lists that are often required in conventional furniture fabrication.

With reference again to FIG. 1, edges of various segments, including leg segments 20, 22, 24, 26 couple together edge to edge using box joint such that edges of the adjacent segments interconnect.

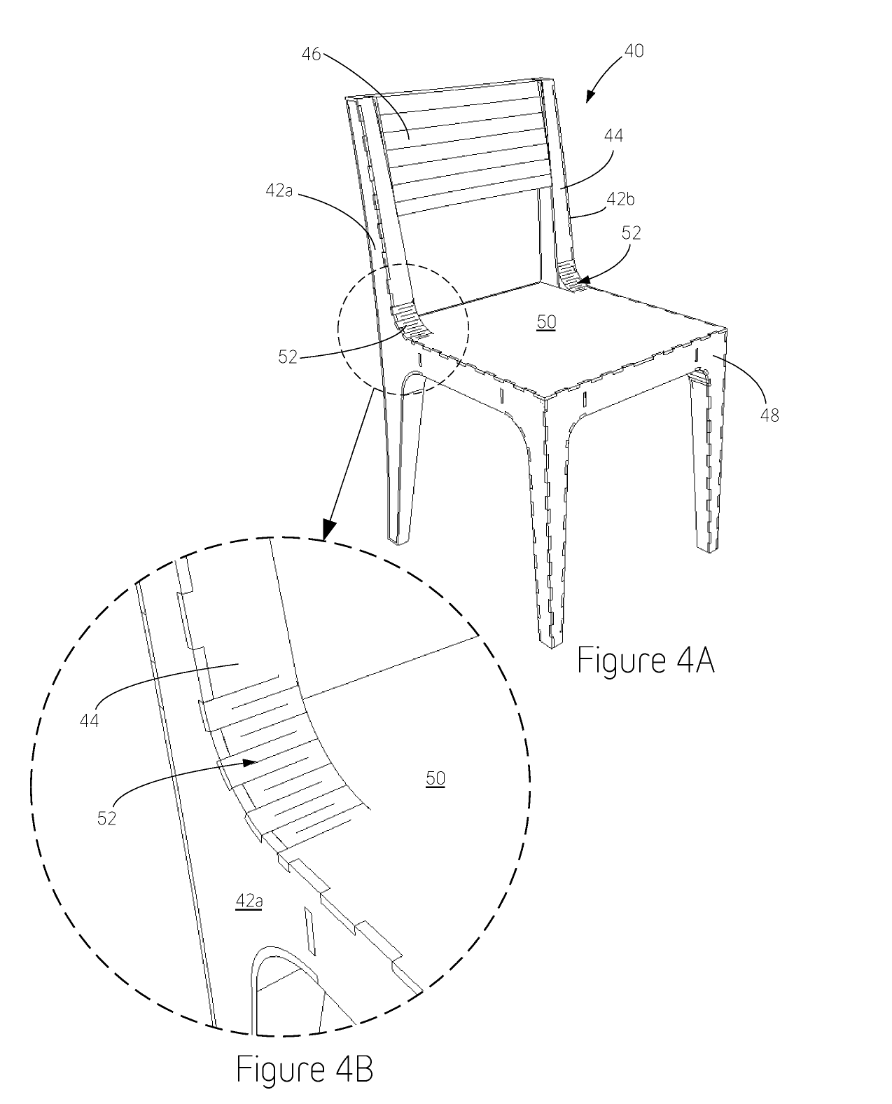

With reference now to FIGS. 4A-4B, a chair 40 is depicted having a monocoque structure implementing design features previously discussed. The chair includes side/leg segments 42a, b that attach to a seat/back segment 44, which includes a backrest segment 46, via interlocking joints on adjacent edges. Similarly, seat segment 44 attaches to a front leg segment 48 by interlocking joints on adjacent edges of the frame segments. The seat segment 50 is connected to backrest segment 44 by transitional regions 52.

The transitional regions 52 are formed via lattice of strips connected minimally at alternating ends that allow the wood to bend upward from the seat portion to the back rest portion of the chair, which is also referred to as kerfing, in which a series of cuts in close proximity are provided to allow the wood segment to bend from the base of the seat to the back support.

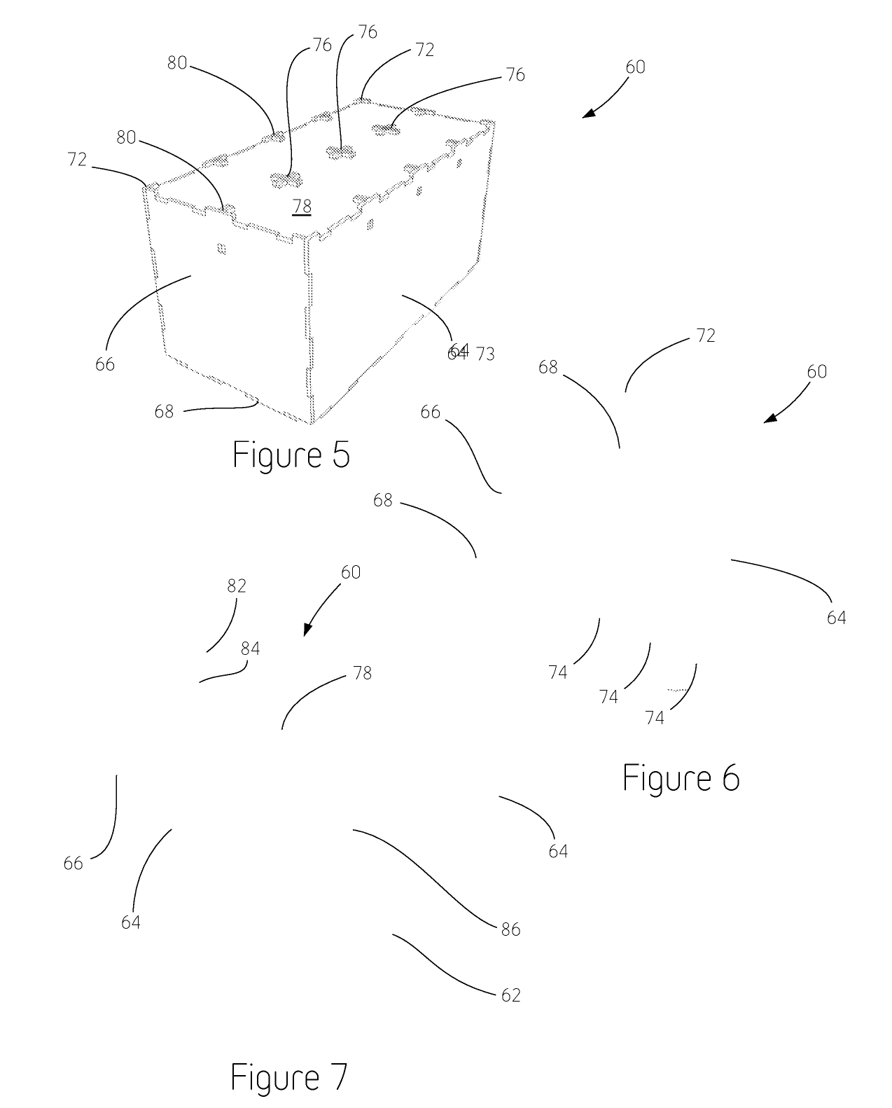

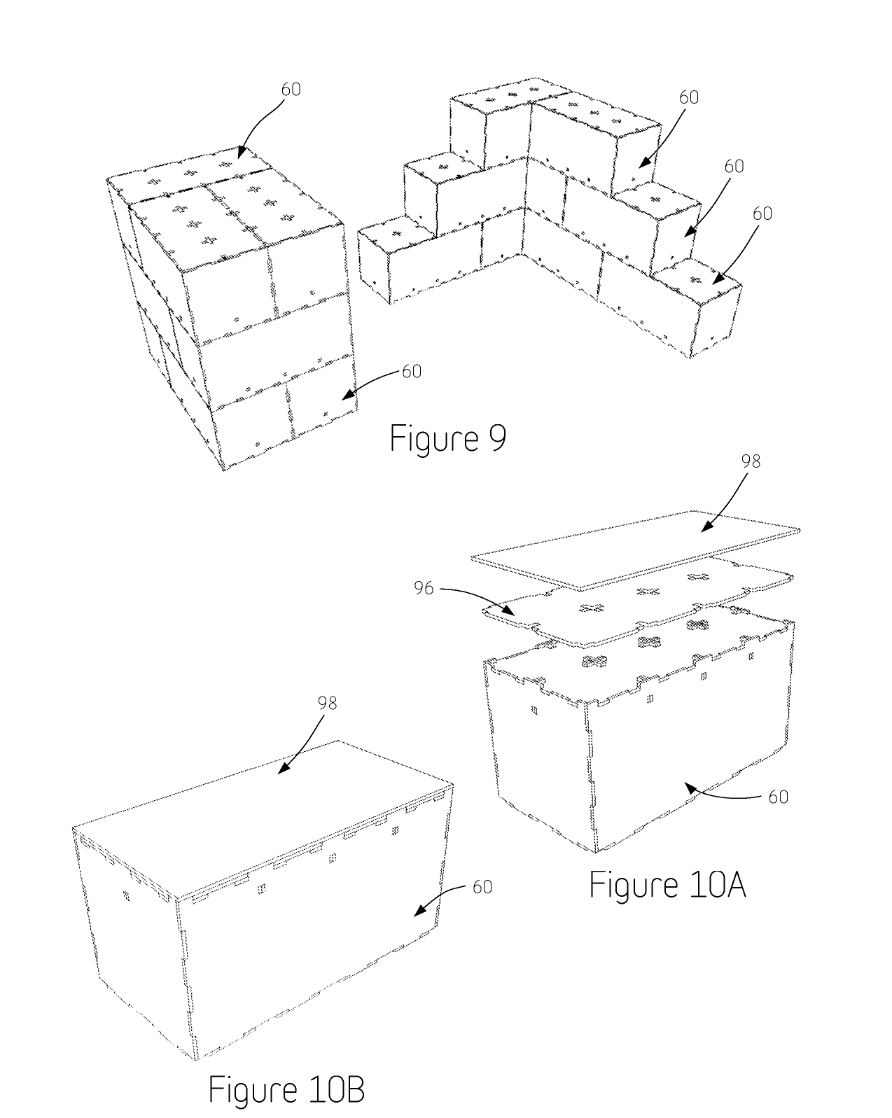

With reference now to FIGS. 5-7, a furniture block 60 is shown configured to interlock in stacked arrangements. The bottom base 62 of the block furniture attaches to the sidewalls 64 and 66 by interlocking joints 68 on adjacent edges of each segment. The bottom base 62 and sidewalls attach to form corners 72 of the block furniture. The bottom segment 62 defines female portions 74 of an interlocking connection that allows alignment and connection of adjacent blocks in a variety of positions and orientations. The block 60 includes a plurality of male portions 76 of the interlocking connection that project from a top segment 62. Box joint components 80 provided about the periphery of the block on sidewalls to provide supplemental structural support and alignment of several furniture blocks stacked together (e.g., FIG. 9).

FIG. 7 illustrates a partially exploded view of furniture block in FIG. 5, which further details the reinforced monocoque structure and interlocking joints. The interlocking joints have complementary ridges 82 and grooves 84 that alternate along the edge of the segments. In addition, the top of the block furniture includes a structural backbone 86 located underneath the top segment 78, defining the male portions 76 of the interlocking connection. The structural backbone 86 having portions 76 that project out apertures of the top segment to form the male portions 76. In the exemplary embodiment, the top segment 78 and the bottom segment 62 have the same silhouette.

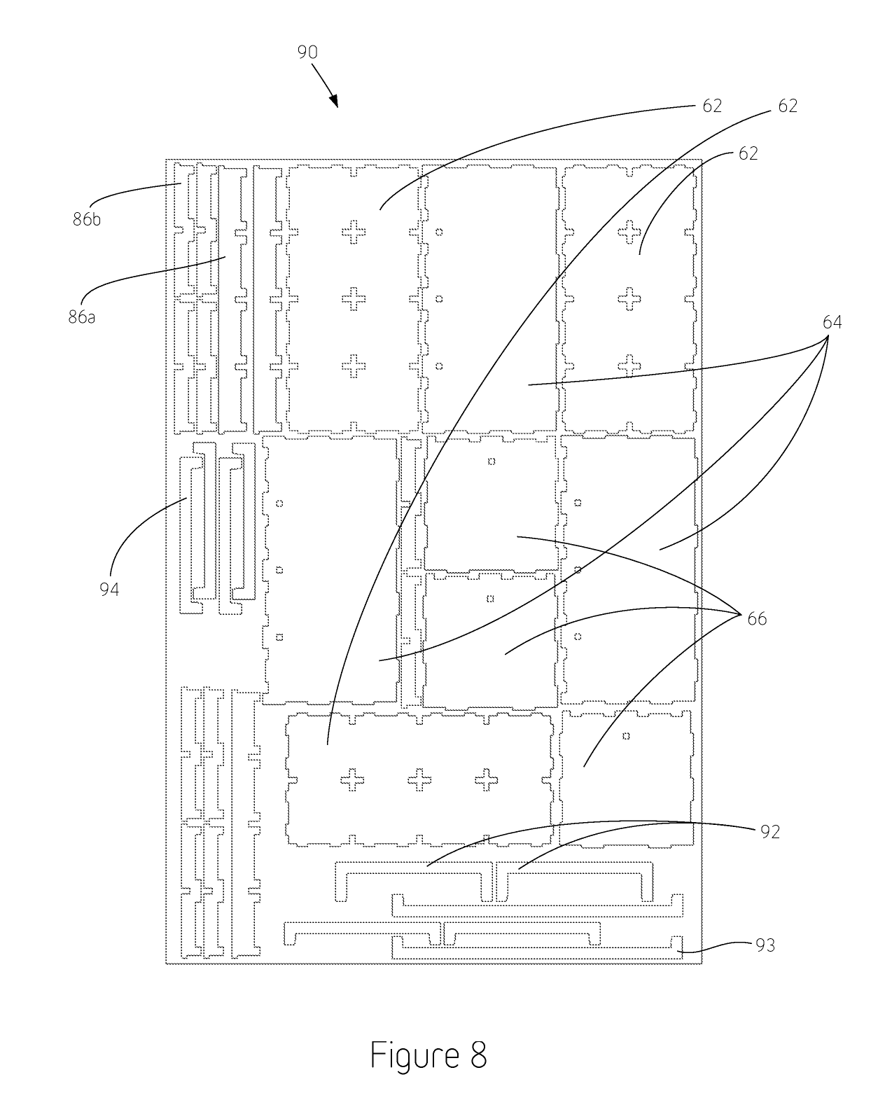

FIG. 8 discloses a plan view of a wood panel 90 pre-scored to define a furniture blocks 60 (FIG. 5). It will be observed that all of the segments comprising the entire furniture are cut from a single panel of wood, thereby optimizing available space and greatly reducing waste. More particularly, each panel 90 has sufficient segment to form 1.5 blocks. Thus, furniture kits can be compactly packaged, thereby decreasing transportation costs. Furthermore, no parts are directly on the edge or corners so that the segments are protected during shipping.

The top and bottom segments 62 and lateral walls 64 and 66 are pre-scored in specific arrangement to optimize space within the blank 90. Likewise, the structural backbone and other structural support components are pre-scored in a specific arrangement to maximize the number of components that can be placed in a limited amount of space. Components 86a and 86b form the backbone 86 of the block 60. Whereas, components 92, 93 and 94 are not part of the block; rather, these components are jigs to hold the block together, during assembly, while the glue is drying in the initial assembly.

FIG. 9 depicts examples of furniture blocks 60 connected together. Blocks 60 can be used to create any number of furniture structures as desired by a user. The interlocking connections 74, 76 (see FIGS. 5 & 6) facilitate secure connection to enhance stability of the resulting object.

With reference to FIGS. 10A and 10B, a tabletop assembly 96, 98 can be added to the furniture block 60 to create a level, finished surface. The tabletop is formed of segment 96 and segment 98. Segment 96 includes female portions 74 to receive male portions 76, (see FIGS. 5 & 6) and segment 98 fits atop segment 96, provide a finish top surface.

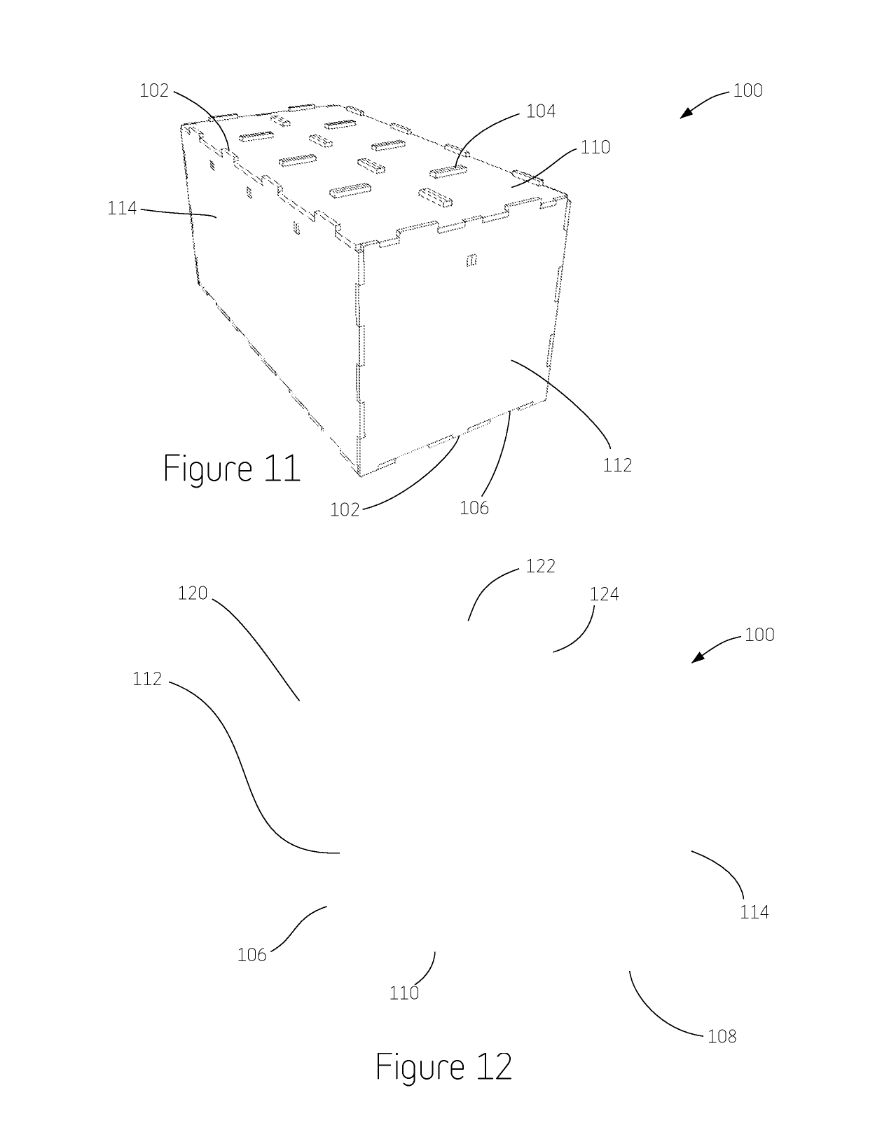

With reference to FIGS. 11 and 12, another embodiment of a furniture block 100 is shown. The block defines interlocking connection comprising male portions 102, 104 that mate with female components 106, 108, allowing alignment and connection of adjacent blocks in a variety of positions and orientations. The bottom segment 110 attaches to sidewalls 112 and 114 by interlocking joints. The top segment 110 attaches to sidewalls 112, 114 by interlocking joints 122, 124. The interlocking connection of block 100 enables users to create a variety of furniture structures using several blocks.

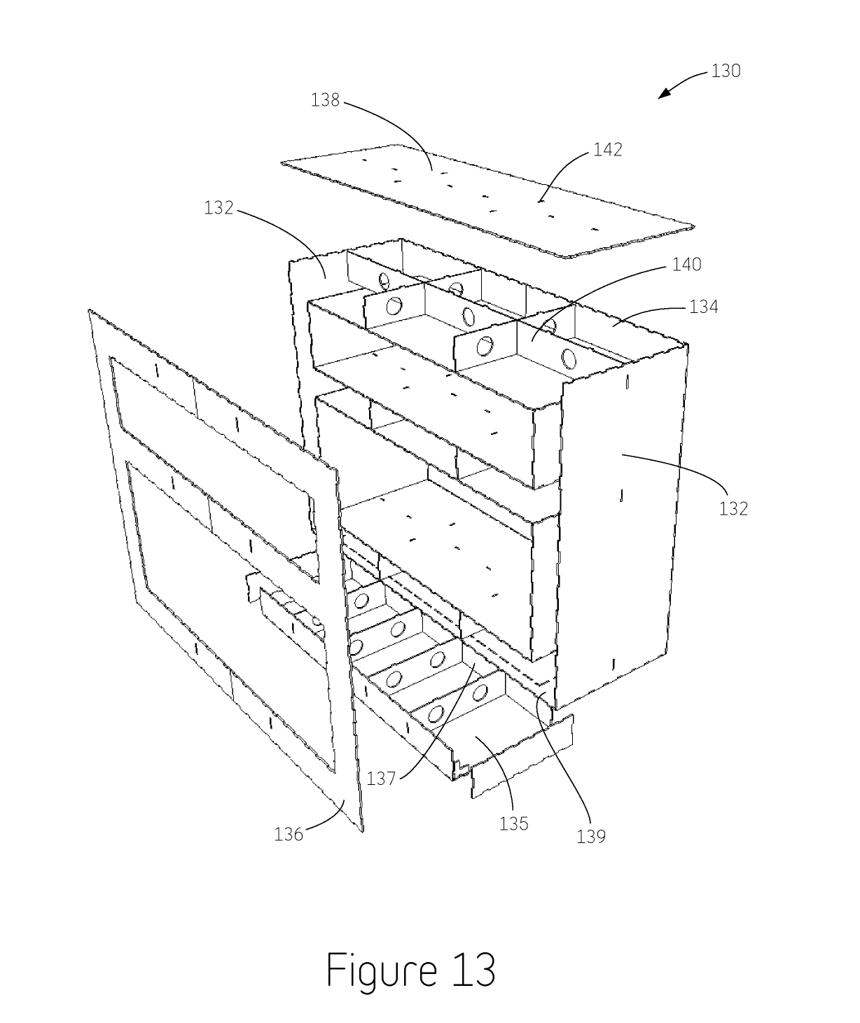

FIG. 13 is a partially exploded perspective view of a shelf assembly 130 having a reinforced monocoque structure, having sidewalls 132, a back segment 134, a front segment 136, and a top segment 138 attached through interlocking joints. The load weight bore down by the top is supported by an internal backbone 140 that attaches through a plurality of slots 142 throughout the top segment and sidewalls. A plurality of other load bearing supports are located in between the shelves.

FIG. 14 is a close-up perspective view of a bottom portion of the shelf assembly 130, depicting a transition region between base 135 and base side segment 137 of the shelf assembly. The base of the shelf 135 has alternating ridges and grooves that allow the back segment 134 and walls to connect at interlocking joints. In addition, there are a plurality of slots 142 allowing support segments 144 to attach perpendicularly to the back wall 134 of the base, and planar parallel to the lateral walls of the base. Furthermore, there is a plurality of two-plane panel brackets 152 and three-plane panel brackets 160 that provide further support at joints.

FIG. 15 is a close-up perspective view of a support segment 152 of the shelf assembly of FIG. 14. The support segment has ridges 158 and grooves 159 that complement a bottom and adjacent segment. Similarly, the vertical and horizontal extension complements adjacent segments.

FIG. 16 is a close-up perspective view of a corner support 160 of the shelf assembly of FIG. 13. The grooves and ridges 158 and 159 complement both the adjacent and bottom segments. The vertical extensions of the corner segments complement each other.

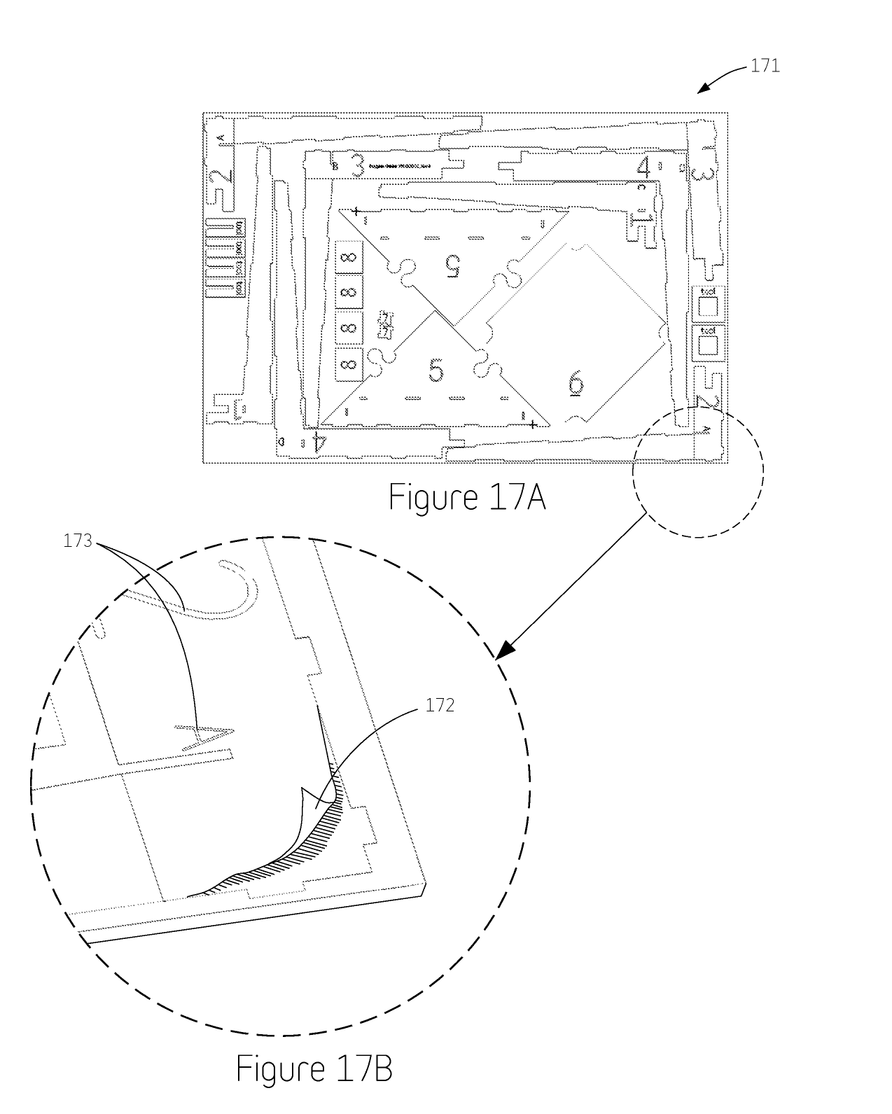

With reference now to FIGS. 17A and 17B, a pre-scored panel 171 includes a protective cover 172 on an exterior surface of the panel. The cover 172 includes assembly instructions printed thereon. More particularly, each of the segments is labeled with designators 173 to assist the user with assembly. Numerical designators are to identify the segment type, and letter designators are used to aid coupling segment joints. The protective cover can be peeled off, prior to or after assembly. As previously mentioned, the panel can be pre-scored with assembly aids, e.g., assembly tools to facilitate alignment of segments as well as to hold segments together during assembly, and while glue sets. Such tools are labeled, e.g., “Tool,” such on the protective cover.

It should be appreciated from the foregoing that the present invention provides monocoque furniture assembly and method of manufacture utilizing modular wood segments connected by interlocking mating joints that are self-registering for ease of assembly. The monocoque structure achieves structural integrity with much thinner sheet material. Preferably, joints are located away from areas of high stress to maximize strength. Part size is reduced for ease of manufacture, shipping, or handling by dividing larger parts with interlocking joints at areas of lower stress. The system can further include a series of reinforcing struts, trusses, ribs and doublers where required that distribute loads as well as a labeling protocol identifying mating assembly points and orientation thereby eliminating the need for lengthy assembly instructions, special skill or training

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A furniture assembly, comprising: a plurality of planar segments coupled to adjacent segments via edge-to-edge interlocking joints to form a structural skin, the segments having a thickness less than 10 mm, the structural skin contributing to load bearing support members having a monocoque structure, the structural skin defining a plurality of flat surfaces.

2. The furniture assembly as defined in claim 1, wherein the edge-to-edge interlocking joints selected from a group consisting of dovetail, combo, and box.

3. The furniture assembly as defined in claim 1, comprising a horizontal surface and a plurality of legs positioned to support the horizontal surface, each leg is includes four leg segments the contribute to the structural skin such that each leg is four sided and substantially hollow.

4. The furniture assembly as defined in claim 3, wherein the leg segments further define a skirt about the periphery of the horizontal surface.

5. The furniture assembly as defined in claim 3, wherein adjacent leg segments connect along the length of corresponding edges via corner joints selected from a group consisting of dovetail, combo, and box.

6. The furniture assembly as defined in claim 1, wherein the plurality of flat surfaces includes a horizontal flat surface, defined by at least two planar segments coupled together with edge-to-edge interlocking joints.

7. The furniture assembly as defined in claim 1, the plurality of planar segments including:
a bottom planar segment defining a plurality of apertures;
an upper planar segment disposed in spaced, parallel arrangement to the bottom segment, defining a plurality of aperture aligned with the apertures of the bottom segment; and
a structural backbone formed of several planar segments, the structure backbone including male portion that extend through the plurality of apertures of the upper segment, the male portions configured to form an interlocking connection with the plurality of apertures of the bottom segment of a second furniture assembly having an identical construction.

8. The furniture assembly as defined in claim 8, the plurality of planar segments including:
a tabletop segment; and
a second upper planar segment sandwiched between the tabletop segment and the first upper segment, the second upper segment defining a plurality of apertures configured to receive the male portions of the structural backbone.

9. A method of manufacturing a furniture assembly, comprising:
providing a planar blank of wood material a thickness less than 10 mm; and
scoring the planar blank to define a plurality of planar segments, having peripheral edges for forming edge-to-edge interlocking joints, such that the plurality of wooden segments can be coupled to adjacent segments via edge-to-edge interlocking joints to form a structural skin, the structural skin contributing to load bearing support members having a monocoque structure.

10. The method as defined in claim 9, wherein the planar blank has a front surface and a back surface includes a protective cover sized to cover the front surface and removably attached thereto.

11. The method as defined in claim 10, wherein the protective cover is printed with assembly instructions, including indicia positioned to correspond to each of the plurality of wooden segments.

12. The method as defined in claim 9, wherein the edge-to-edge interlocking joints selected from a group consisting of dovetail, combo, and box.

13. The method as defined in claim 9, wherein the plurality of flat surfaces includes a horizontal flat surface, defined by at least two planar segments coupled together with edge-to-edge interlocking joints.

14. The method as defined in claim 9, comprising a horizontal surface and a plurality of legs positioned to support the horizontal surface, each leg includes four leg segments the contribute to the structural skin such that each leg is four sided and substantially hollow.

15. The method as defined in claim 14, wherein the leg segments further define a skirt about the periphery of the horizontal surface.

16. The method as defined in claim 14, wherein adjacent leg segments connect along the length of corresponding edges via corner joints selected from a group consisting of dovetail, combo, and box.

17. The method as defined in claim 9, wherein the scoring step includes a computer numerical control tool (CNC) programmed to define the plurality of planar segments.

18. The method as defined in claim 9, further comprising: assembling a furniture piece, by removing the plurality of planar segments from the score blank, aligning corresponding segments of the plurality of segment, and applying glue to the edge-to-edge interlocking joints.
